(19) United States
(12) Patent Application Publication
(10) Pub. No.: US 2003/0227431 A1
(43) Pub. Date: Dec. 11, 2003

(54) Method and circuit for LCD panel flicker reduction

(76) Inventors: Te Cheng Chung, Tao-Yuan (TW); Seok Lyul Lee, Tao-Yuan (TW); Tean Sen Jen, Tao-Yuan (TW); Ming Tien Lin, Taipei (TW)

Correspondence Address: MERCHANT & GOULD P.C., P.O. Box 2903, Minneapolis, MN, 55402-0903, US

(21) Appl. No.: 10/395,595

(22) Filed: Mar. 25, 2003

(30) Foreign Application Priority Data
Jun. 7, 2002 (TW) 091112397

(51) Int. Cl. G09G 3/36

(52) U.S. Cl. 345/98

(57) ABSTRACT

A method and circuit for LCD panel flicker reduction. The invention relates to an adjustment circuit to reduce an LCD panel flicker, wherein the LCD panel has a plurality of scan lines and a plurality of data lines. In one embodiment, the adjustment circuit includes a variable resistor, and a plurality of impedance adjustment devices, each with impedance and having a control terminal to be coupled with a DC voltage source through the variable resistor, a power terminal to be coupled with a common voltage source, and a scan line terminal to be coupled with a scan line, wherein the impedance of each of the impedance adjustment devices can be varied when the resistance of the variable resistor is varied. Each of the impedance adjustment devices in one embodiment has a transistor. The impedance of each of the impedance adjustment devices is much higher than the impedance of the corresponding scan line to allow the LCD to be operated at higher frequencies.

### BACKGROUND OF THE INVENTION

1. Field of the Invention

This invention relates to a method and circuit for liquid crystal display (LCD) panel flicker reduction, particularly to an adjustment circuit to be added to an LCD panel, thus reducing LCD panel flicker.

2. Description of the Related Art

In recent years, LCDs are increasingly popular due to smaller space requirement and lower power consumption. Large-size and high resolution LCDs are replacing conventional displays such as cathode ray tube (CRT) displays. However, such LCDs generally have flicker on the panels, which becomes more severe when the size of the LCD increases.

An LCD generally uses AC driving because electrical breakdown is caused by long-term bias voltage being applied. The AC driving means that data is changed between positive and negative regions. A diagram of inversion driving types of a typical LCD is shown in FIG. 1a. In FIG. 1a, symbol “+” is positive driving and symbol “−” is negative driving. AC driving of an LCD can be divided into frame inversion, row inversion, column inversion and dot inversion. Additionally, scan signal potential has two types. For example, the tri-state of scan line potential is high potential V_{high}, low potential V_{low} and compensation potential V_{gc}, where V_{high}>V_{low}>V_{gc}.

A schematic diagram of a typical LCD1 is shown in FIG. 1b. In FIG. 1b, the LCD includes a gate driver 10, a data driver 22 and an LCD panel. The LCD panel includes interlaced data lines and scan lines, which control display units. If one terminal of a display unit is connected to a common voltage source with common voltage level V_{com}, such a structure is referred as a capacitance coupling on common (Cs on Common) structure. If the one terminal of the display unit is connected to another scan line providing the voltage level, such a structure is referred as a capacitance coupling on gate (Cs on Gate) structure. LCD 1 as show in FIG. 1b has the Cs on Gate structure. For example, the data line 18a and the scan line 20b control a display unit or unit 13, which includes a transistor 12ba, a capacitor 14ba and a liquid crystal unit 16ba. Gate and drain of the transistor 12ba are respectively connected to the scan line 20b and the data line 18a to control transistor 12ba on/off by means of scan signal on the scan line 20b in order to write data signal on the data line 18a in the devices 14ba and 16ba of the unit 13. Data signal is stored in capacitor in voltage level to drive the liquid crystal unit 16ba. Another terminal of the capacitor 14ba is connected to the scan line 20a. When the scan line 20b is enabled, the scan line 20a thus presents a voltage level. The scan driver 10 sequentially outputs scan signals on the scan lines 20a, 20b, . . . , 20m, such that transistors in a row of display units are instantly turned on and transistors in other rows are turned off. When the transistors are turned on, the data driver 22 outputs corresponding data signals to the row of display units through the data lines 18a, 18b, . . . , 18n according to image data to be displayed. Accordingly, repeating the above scan and output operations can complete the desired image display. However, every scan line is a wire with impedance and connects a plurality of capacitors through a plurality of transistors.

Therefore, as known to people skilled in the art, scan signal will be affected by RC effect so as to change the waveform. For example, a scan signal on scan line 20b turns transistor 12ba on/off using a normal wave but turns transistor 12bn on/off using a deformed wave due to the RC effect. Both normal and deformed waves can offer a similar function but may cause an error in the deformed waveform. For example, the on/off may result in capacitor 16ba experiencing a correct data signal but capacitor 16bn experiencing an incorrect data signal. Further, the correct and incorrect data signals cause brightness or chromatic difference on an LCD which causes perceived flicker for views due to positive and negative cycle changes. The flicker intensifies with larger LCDs at higher operating frequencies.

Consequently, there is a need to develop new method and devices for LCD panel flicker reduction.

### SUMMARY OF THE INVENTION

The present invention relates to a method and circuit for liquid crystal display (LCD) panel flicker reduction of an LCD panel.

In one aspect, the invention relates to an adjustment circuit to reduce an LCD panel flicker, wherein the LCD panel has a plurality of scan lines and a plurality of data lines. In one embodiment, the adjustment circuit includes a variable resistor, and a plurality of impedance adjustment devices, each with impedance and having a control terminal to be coupled with a DC voltage source through the variable resistor, a power terminal to be coupled with a common voltage source, and a scan line terminal to be coupled with a scan line, wherein the impedance of each of the impedance adjustment devices can be varied when the resistance of the variable resistor is varied. Each of the impedance adjustment devices in one embodiment has a transistor. The impedance of each of the impedance adjustment devices is much higher than the impedance of the corresponding scan line. And the common voltage source provides a common voltage signal with a voltage level in a range of between a high and a low voltage levels.

In another aspect, the invention relates to an LCD panel. In one embodiment, the LCD panel includes a plurality of scan lines, each having a first terminal and a second terminal, a plurality of data lines that interlaced to the plurality of scan lines, a plurality of display units disposed in each interlaced scan line and data line, a data driver connected to the data lines, a gate driver connected to first terminals of the scan lines, a variable resistor, and a plurality of impedance adjustment devices. Each of the impedance adjustment devices has a scan line terminal to be connected to a second terminal of a corresponding scan line, a control terminal to be coupled with a DC voltage source through the variable resistor and a power terminal to be coupled with a common voltage source, wherein the impedance of each impedance adjustment device can be varied when the resistance of the variable resistor is varied. Each of the impedance adjustment devices in one embodiment has a transistor. The impedance of each of the impedance adjustment devices is much higher than the impedance of the corresponding scan line. And the common voltage source provides a common voltage signal with a voltage level in a range of between a high and a low voltage levels.

In yet another aspect, the invention relates to a method for LCD panel flicker reduction of an LCD panel. In one embodiment, the LCD panel has a plurality of scan lines, each having a first terminal and a second terminal, a plurality of data lines that interlaced to the plurality of scan lines, a plurality of display units disposed in each interlaced scan line and data line, a variable resistor, and a plurality of impedance adjustment devices, each having a scan line terminal to be connected to a second terminal of a corresponding scan line, a control terminal to be coupled with a DC voltage source through the variable resistor and a power terminal to be coupled with a common voltage source. The method includes the step of changing resistance of the variable resistor to vary impedance of at least one impedance adjustment device to reduce the panel flicker. Each of the impedance adjustment devices in one embodiment has a transistor. The impedance of each of the impedance adjustment devices is much higher than the impedance of the corresponding scan line. And the common voltage source provides a common voltage signal with a voltage level in a range of between a high and a low voltage levels.

These and other aspects of the present invention will become apparent from the following description of the preferred embodiment taken in conjunction with the following drawings, although variations and modifications therein may be affected without departing from the spirit and scope of the novel concepts of the disclosure.

### DESCRIPTION OF THE DRAWINGS

FIG. 1a is a diagram of inversion driving types of a typical LCD.

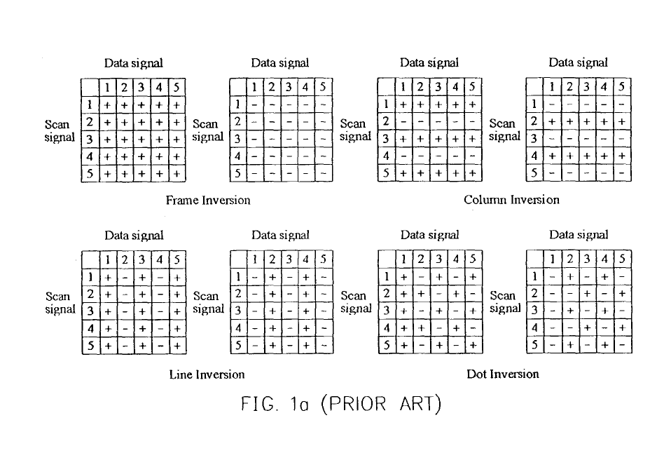

FIG. 1b is a schematic block diagram of a typical LCD.

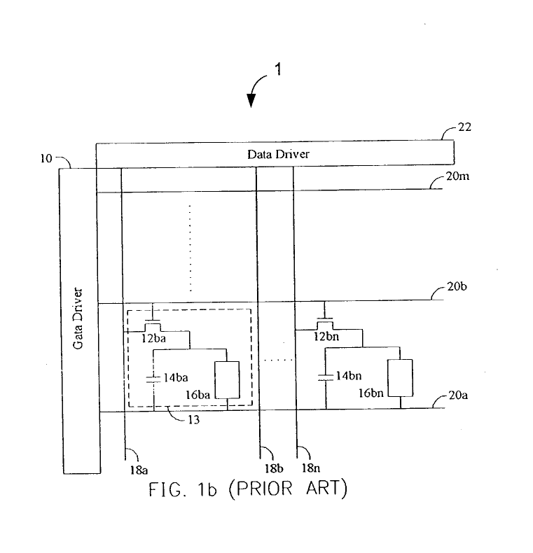

FIG. 2 is a schematic block diagram of an LCD according to one embodiment of the invention.

FIG. 3 is a flowchart schematically showing how to reduce the panel flicker in association with the LCD of FIG. 2 according to one embodiment of the invention.

### DETAILED DESCRIPTION OF THE INVENTION

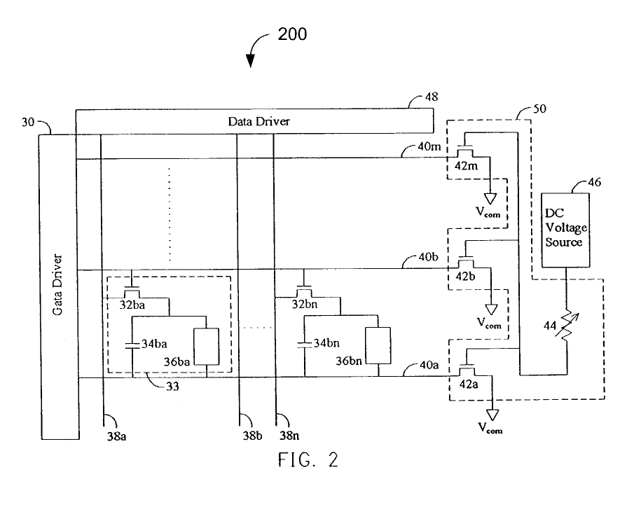

Referring now to FIG. 2, a schematic block diagram of an LCD 200 according to one embodiment of the invention is shown. In FIG. 2, the LCD 200 includes a gate driver 30, a data driver 48, interlaced data lines 38a to 38n and scan lines 40a to 40m, display units 33 and an adjustment circuit 50. As shown in FIG. 2, the gate driver 30 selects one of the scan lines and the data driver 48 selects one of the data lines in order to assign one of the display units to be operated. Moreover, all terminals not connected to the gate driver 30 of the scan lines are connected to the circuit 50. A display unit 33 is selected through data line 38a and scan line 40b. The unit 33 includes a transistor 32ba, a capacitor 34ba and a liquid crystal unit 36ba. Gate and drain of the transistor 32ba are respectively connected to the scan line 40b and the data line 38a to control the transistor 32ba on/off by scan signal on the scan line 40b in order to write data signal on the data line 38a in the capacitor 34ba and the liquid crystal unit 36ba of the unit 33. Data signal is stored in the capacitor 34ba by means of voltage level to drive the unit 36ba. Another terminal of the capacitor 34ba is connected to the scan line 40a. When the scan line 40b is enabled, the scan line 40a can provide a compensation voltage Vgc.

The adjustment circuit 50 has a variable resistor 44 and a plurality of impedance adjustment devices 42a to 42m. The devices 42a to 42m each includes a transistor. Control terminals, scan line terminals and power terminals of the devices 42a to 42m are respectively connected to the variable resistor 44, scan lines and the common voltage source with common voltage V_{com}. A DC voltage source 46 provides a DC voltage through the resistor 44 to supply a driving voltage to drive the devices 42a to 42m, and the impedance of each of the devices 42a to 42m is much higher than the impedance of each of the scan lines. The gate driver 30 sequentially outputs the scan lines 40a, 40b, . . . , 40m such that transistors in a row of display units are instantly turned on and transistors in other rows are turned off.

When the transistors are turned on, the data driver 22 outputs the corresponding data signals to the row of display units through data lines 38a, 38b, . . . , 38n according to image data to be displayed. At this point, because the impedances of the impedance adjustment devices 42a to 42m are much higher than the impedances of the scan lines 40a to 40m, respectively, the impedances of scan lines 40a to 40m can be neglected. Therefore, scan signal on the scan line 40b appropriately keeps the same waveform as an original input signal when driving the capacitors 34ba and 34bn, which is superior to the prior art LCD can offer. For example, according to the practical measurement, in one embodiment, the voltage difference between the data signals stored in the capacitors 34ba and 34bn and in the capacitors 14ba and 14bn were measured and compared, the former was 24.8 mV while the latter was 45 mV (due to data signal stored in a capacitor by means of voltage level) during positive driving, and the former was 45 mV while the latter was 160 mV during negative driving. Therefore, the LCD 200 according to one embodiment of the invention can provide much less brightness or chromatic difference than that of a prior art LCD panel such that the panel flicker is reduced.

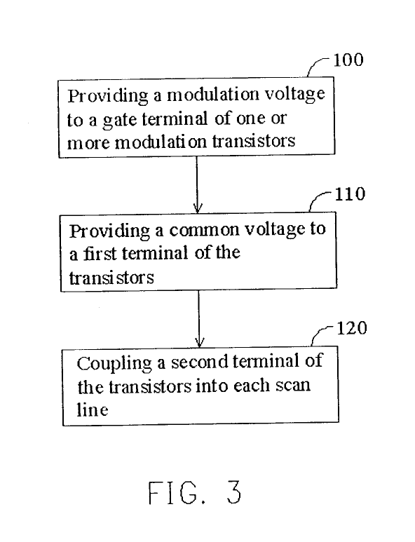

Referring now to FIG. 3, a method for reducing the panel flicker in association with the LCD of FIG. 2 according to one embodiment of the invention is shown.

In step 100, a plurality of impedance adjustment devices 50 are coupled to first terminals of a plurality of scan lines of the LCD panel one-to-one, i.e., scan terminals of the devices 42a to 42m in the adjustment circuit 50 are coupled to the scan lines 40a to 40m one-to-one, correspondingly.

In step 110, control terminals of the impedance adjustment devices 50 are coupled to a DC voltage source 46 through a variable resistor, i.e., control terminals of the devices 42a to 42m in the adjustment circuit 50 are coupled to the variable resistor 44 connected to the DC voltage source 46.

In step 120, voltage terminals of the impedance adjustment devices 50 are coupled to a common voltage source, i.e., voltage terminals of the devices 42a to 42m in the adjustment circuit 50 are coupled to the common voltage source (not shown) with common voltage level V_{com}.

In operation, resistance of the variable resistor 44 is changed so as to vary impedance of every or at least one impedance adjustment device 50 to reduce panel flicker, i.e., the impedance of the variable resistor 44 is changed such that the impedances of the impedance adjustment devices are greatly higher than the impedances of the scan lines such that the impedances of scan lines can be neglected. Consequently, the RC effect associated with the prior art LCD panel is eliminated.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adjustment circuit for reducing liquid crystal display (LCD) panel flicker for an LCD panel, wherein the LCD panel has a plurality of scan lines and a plurality of data lines, comprising:
a variable resistor; and
a plurality of impedance adjustment devices, each with impedance and having:
a. a control terminal to be coupled with a DC voltage source through the variable resistor;
b. a power terminal to be coupled with a common voltage source; and
c. a scan line terminal to be coupled with a scan line,
wherein the impedance of each of the impedance adjustment devices is varied when the resistance of the variable resistor is varied.

2. The adjustment circuit of claim 1, wherein each of the impedance adjustment devices comprises a transistor.

3. The adjustment circuit of claim 1, wherein the impedance of each of the impedance adjustment devices is much higher than the impedance of the corresponding scan line.

4. The adjustment circuit of claim 1, wherein the common voltage source provides a common voltage signal with a voltage level between a high and a low voltage levels.

5. An LCD panel, comprising:
a plurality of scan lines, each having a first terminal and a second terminal;
a plurality of data lines that interlaced to the plurality of scan lines;
a plurality of display units disposed in each interlaced scan line and data line;
a data driver connected to the data lines;
a gate driver connected to first terminals of the scan lines;
a variable resistor; and
a plurality of impedance adjustment devices, each having a scan line terminal to be connected to a second terminal of a corresponding scan line, a control terminal to be coupled with a DC voltage source through the variable resistor and a power terminal to be coupled with a common voltage source, wherein the impedance of each impedance adjustment device is varied when the resistance of the variable resistor is varied.

6. The LCD panel of claim 5, wherein each of the impedance adjustment devices comprises a transistor.

7. The LCD panel of claim 5, wherein the impedance of each of the impedance adjustment devices is much higher than the impedance of the corresponding scan line.

8. The LCD panel of claim 5, wherein the common voltage source provides a common voltage signal with a voltage level between a high and a low voltage levels.

9. A method for LCD panel flicker reduction of an LCD panel, wherein the LCD panel has a plurality of scan lines, each having a first terminal and a second terminal, a plurality of data lines that interlaced to the plurality of scan lines, a plurality of display units disposed in each interlaced scan line and data line, a variable resistor, and a plurality of impedance adjustment devices, each having a scan line terminal to be connected to a second terminal of a corresponding scan line, a control terminal to be coupled with a DC voltage source through the variable resistor and a power terminal to be coupled with a common voltage source, comprising the step of:
changing resistance of the variable resistor to vary impedance of at least one impedance adjustment device to reduce the panel flicker.

10. The adjustment circuit of claim 9, wherein each of the impedance adjustment devices comprises a transistor.

11. The adjustment circuit of claim 9, wherein the impedance of each of the impedance adjustment devices is much higher than the impedance of the corresponding scan line.

12. The adjustment circuit of claim 9, wherein the common voltage source provides a common voltage signal with a voltage level between a high and a low voltage levels.
